(19) United States
(12) Patent Application Publication
(10) Pub. No.: US 2025/0189050 A1
(43) Pub. Date: Jun. 12, 2025

(54) EXTRACTION VALVE AND VACUUM COLLECTION SYSTEM

(71) Applicant: Acorn Engineering Company, City of Industry, CA (US)

(72) Inventors: Thomas K. Zinn, Chino Hills, CA (US); Carlos J. Galeazzi, Rancho Cucamonga, CA (US)

(21) Appl. No.: 18/971,995

(22) Filed: Dec. 6, 2024

Related U.S. Application Data
(60) Provisional application No. 63/607,473, filed on Dec. 7, 2023.

(51) Int. Cl. F16K 15/06; E03F 1/00; F16K 31/122

(52) U.S. Cl. CPC F16K 15/063; E03F 1/007; F16K 31/1221

(57) ABSTRACT

An extraction valve and vacuum liquid collection system including the extraction valve. The extraction valve includes a valve body having an inlet port defining an inlet passageway, an outlet port defining an outlet passageway, and portions defining a valve seat generally located between the inlet port and the outlet port. A bonnet is mounted to the valve body and cooperates with the valve body to define a fluid chamber communicating the inlet port with the outlet port. The bonnet includes a valve member disposed within the fluid chamber and moveable between engaged and disengaged position with the valve seat. In the engaged position, the valve member prevents fluid communication between the inlet port and the outlet port. Also provided in the valve body is an induction port coupled to a source of ambient or greater pressure air and defining a passageway in fluid communication with the fluid chamber.

### CROSS-REFERENCE TO RELATED APPLICATION

This application is a non-provisional application claiming the benefit of U.S. application Ser. No. 63/607,473, filed Dec. 7, 2023, the entire contents of which are herein incorporated by reference.

### BACKGROUND

### 1. Field of the Invention

The present invention generally relates to liquid collection systems that utilize vacuum to transport liquid through the system. More specifically, the invention relates to an extraction valve for such a system.

### 2. Description of Related Art

Vacuum sewage systems are sewage systems that utilize a pressure differential to transport sewage through the system. This is in contrast to gravity operated systems, in which gravity is utilized to cause the sewage to flow through the system, and positive pressure systems, in which active pumping causes the sewage to flow through the system. A vacuum sewage system can be used where conditions are not suitable for gravity or positive pressure systems and can be found in commercial buildings, institutional settings and residential developments.

Generally, a vacuum sewage system includes a plurality of collection devices (e.g., a toilet, urinal, sink basin, shower pan or bathtub) coupled to one or more accumulators, where the waste liquid is collected. Waste piping, maintained under vacuum, couples the accumulators to a vacuum sub-system, which may include one or more vacuum pumps, waste collection tanks, and discharge plumbing (which is typically gravitationally operated, but may include a pressure pump). Extraction valves are provided with the waste piping (hereafter “vacuum pipe(s)”) and divide the vacuum pipes into upstream and downstream sections, respectively extending to the accumulator(s) and to the waste collection tank(s), where it may be further distributed to a wastewater treatment facility by the discharge plumbing and an appropriate sewer line.

During operation, a vacuum (a reduced or negative pressure) is applied to the downstream section of the vacuum pipe. When a signal indicates that an accumulator is sufficiently full, the valve controller (which may be automated or manual) causes the associated extraction valve to open, exposing the corresponding upstream section of the vacuum pipe to the reduced pressure of the downstream section of the vacuum pipe. As a result, wastewater is drawn from the accumulator and sent to the waste collection tank.

As the extraction valve closes, a high degree of pressure differential exists within the valve. As a result, it is possible that the valve will experience an anomaly known as cavitation. Cavitation is the process of forming the vapor phase of a liquid when the liquid is subjected to reduced pressures at constant ambient temperature. It may be thought of as the process of boiling a liquid through pressure reduction rather than heat addition. Cavitation happens in valves when there is a substantial pressure differential between the inlet and the outlet, and in particular, when the fluid in the valve accelerates rapidly. When the downstream pressure rapidly exceeds the “critical point” (the fluid vapor pressure), cavitation occurs. This anomaly can be very destructive to the valve, the piping and/or other components system located downstream of the valve.

### SUMMARY

In satisfying the above need, as well as overcoming the enumerated drawbacks and other limitations of the related art, the present invention provides an extraction valve and a vacuum sewage system incorporating the same.

Accordingly, in one aspect the invention provides an extraction valve including a valve body having an inlet port defining an inlet passageway, an outlet port defining an outlet passageway, and portions defining a valve seat generally located between the inlet port and the outlet port. A bonnet is mounted to the valve body and cooperates with the valve body to define a fluid chamber communicating the inlet port with the outlet por. The bonnet includes a valve member disposed within the fluid chamber and moveable between an engaged position with the valve seat and a disengaged position with the valve seat. In the engaged position, the valve member prevents fluid communication between the inlet port and the outlet port. An induction port is defined in the valve body and provides a passageway for communicating ambient pressure with the fluid chamber.

In another aspect, the induction port is located upstream of the valve seat.

In a further aspect, the induction port is located in a side wall of the valve body.

In an additional aspect, the passageway of the induction port has a cross-sectional area smaller than a cross-sectional area of the inlet passageway.

In another aspect, the induction port is coupled to a source of ambient pressure.

In another aspect, the invention provides a wastewater collection system comprising: a wastewater collection device; an accumulator, the wastewater collection device being coupled to the accumulator whereby wastewater from the collection device is transferred to the accumulator; a vacuum pipe, the vacuum pipe having an upstream portion and a downstream portion, the upstream portion being coupled to the accumulator; an extraction valve coupled to the vacuum pipe; a valve controller, the valve controller coupled to the extraction valve; and a vacuum pump, the vacuum pump coupled to the downstream portion of the vacuum pipe; the extraction valve including a valve body, the valve body having an inlet port defining an inlet passageway, an outlet port defining an outlet passageway, and portions defining a valve seat generally located between the inlet port and the outlet port, a bonnet, the bonnet being mounted to the valve body and cooperating with the valve body to define a fluid chamber communicating the inlet port with the outlet port, the bonnet including a valve member disposed within the fluid chamber and being moveable between first position engaged with the valve seat and a second position disengaged from the valve seat, in the first position the valve member preventing fluid communication between the inlet port and the outlet port, and an induction port defined in the valve body, the induction port defining a passageway in fluid communication with the fluid chamber.

In another aspect, the induction port is located upstream of the valve seat.

In a further aspect, the induction port is located in a side wall of the valve body.

In an additional aspect, the passageway of the induction port has a cross-sectional area smaller than a cross-sectional area of the inlet passageway.

In another aspect, the induction port is coupled to a source of ambient pressure.

Further objects, features and advantages of this invention will become readily apparent to persons skilled in the art after review of the following description, including the claims, and with reference to the drawings that are appended to and form a part of this specification.

### BRIEF DESCRIPTION OF THE DRAWINGS

FIG. 1 is a schematic illustration of a vacuum sewage system incorporating an extraction valve.

FIG. 2 is a cross-sectional view of an extraction valve, in accordance with the principles of the present invention, in a closed state.

FIG. 3 is a cross-sectional view of the extraction valve of FIG. 2 shown in an open state.

### DETAILED DESCRIPTION

As used in the description that follows, directional terms such as “upper” and “lower” are used with reference to the orientation of the elements as presented in the figures. Accordingly, “upper” indicates a direction toward the top of the figure and “lower” indicates a direction toward the bottom of the figure. The terms “left” and “right” are similarly interpreted. The terms “inward” or “inner” and “outward” or “outer” indicate a direction that is generally toward or away from a central axis of the referred to part, whether or not such an axis is designated in the figures. An axial surface is therefore one that faces axially, in a direction along the central axis. Contrastingly, a radial surface faces radially, in a direction generally away from or toward the central axis. It will be understood, however, that in actual implementation, the directional references used herein may not necessarily correspond with the installation and orientation of the corresponding components or device.

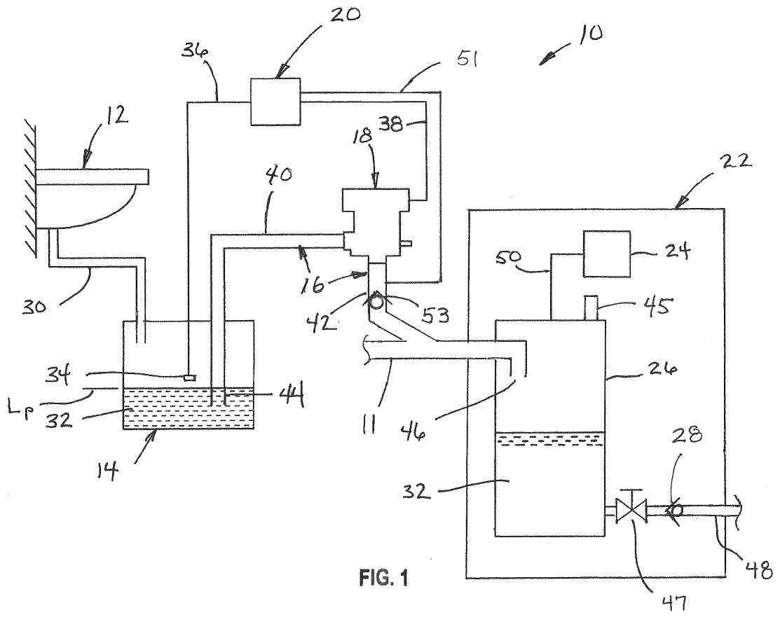

Referring now to the drawings, a vacuum sewage or wastewater collection system embodying the principles of the present invention is schematically illustrated in FIG. 1 and designated at 10. For simplicity, the vacuum system 10 is illustrated with a single wastewater sewage collection site, e.g. a lavatory. It will be appreciated, however, that in actual application the system 10 may and most likely would employ a plurality of wastewater collection sites connected to a main collection line 11. As its main components, the vacuum system 10 may include a collection device 12, an accumulator 14, a vacuum pipe 16, an extraction valve 18, a valve controller 20, and a vacuum sub-system 22. The vacuum sub-system 22 may further include a vacuum pump 24, a waste collection tank 26, discharge plumbing 48 (which is typically gravity assisted, but which may alternative include a pressure pump), a check valve 28 and a ball valve 47, the latter of which is utilized when servicing the vacuum sub-system 22.

Additionally, while the vacuum system 10 is being specifically described in connection with sewage and wastewater collection, it will be appreciated that the vacuum system 10 may be employed in wide variety of the liquid collection applications. Accordingly, the present disclosure is not intended to be and should not be interpreted as limiting the invention sewage and/or wastewater applications.

The collection device 12 is generically illustrated. The collection device 12 may be a black water collection device, such as a toilet or urinal, or a gray water collection device, such as a sink basin, shower pan or bathtub, or other liquid collection devices. It will be further appreciated that the collection device(s) 12 itself may be a gravity operated device, a positive pressure device or a vacuum assisted device. Regardless, the collection device(s) 12 is coupled to the accumulator 14 by a collection line 30, which directs the collected liquid and waste 32 (hereafter just “liquid 32”) into to the accumulator 14, where it remains until a predetermined volume of liquid 32 has been received.

To detect when the level of liquid 32 in the accumulator 14 has reached the predetermined level, a level sensor 34 is provided in the accumulator 14. The level sensor 34 may be any type of sensor capable of sensing the level of the liquid 32 in the accumulator 14. As such the level sensor 34 may be a float sensor, capacitive sensor, ultrasonic sensor, optical sensor or other sensor. When the predetermined level of liquid 32 has been reached in the accumulator 14, the level sensor 34 is triggered and communicates a signal over signal line 36 to an operator or directly to the valve controller 20.

In response to the signal, the valve controller 20 is actuated and causes the vacuum pump 23 to apply vacuum pressure, via vacuum line 38, to the extraction valve 18 and cause the extraction valve 18 to open, i.e. to move from a closed state to an open state. While preferably of the vacuum controller type, the valve controller 20 may be any type of controller that can effectively open the extraction valve 18 in response to a signal from the level sensor 34 that the level of the liquid 32 in the accumulator 14 has reached the predetermined level.

The extraction valve 18 is provided in the vacuum pipe 16 and divides the vacuum pipe 16 into an upstream section 40 and a downstream section 42. As seen in FIG. 1, the upstream section 40 extends into the accumulator 14 and terminates at an inlet opening 44, which is positioned at a location that is lower in the accumulator 14 than the predetermined level (Lₚ) of liquid 32 that triggers removal from the accumulator 14. The downstream section 42 of the vacuum pipe 16 extends from the extraction valve 18 to the main collection line 11 and, ultimately, the vacuum sub-system 22, or more specifically the waste collection tank 26. The upstream and downstream sections 40, 42 of the vacuum pipe 16 cooperate to deliver the liquid 32 from the accumulator 14 to the waste collection tank 26. Notably, the location of the outlet opening 46 of the main collection line 11 into the waste collection tank 26 is at a height above the highest permitted level of liquid 32 within the waste collection tank 26. Stated differently, the location of the outlet opening 46 is at a height above the level at which liquid 32 begins to be evacuated from the waste collection tank 26. To trigger evacuation of liquid 32 from the waste collection tank 26, included in the waste collection tank 26 is a second level sensor (not shown), which, when sensing that the liquid 32 has reached the predetermined level for the waste collection tank 26, initiates removal of the liquid 32 through the discharge plumbing 48.

To remove liquid 32 from the waste collection tank 26, an ambient vent valve 45 is opened so as to depressurize the waste collection tank 26 (pressurization of the waste collection tank 26 is further discussed below) and liquid 32 is caused to be evacuated via the discharge plumbing 48 and a sewer line (not shown) to a wastewater treatment facility (not shown). Optionally, a the positive displacement pump (not shown) may be used to assist with evacuation of the waste collection tank 26.

Vacuum in the vacuum pipe 16, and more specially in the downstream section 42 of the vacuum pipe 16, is established by the vacuum pump 24 of the vacuum sub-system 22. The vacuum pump 24 includes a vacuum line 50 coupled to the waste collection tank 26. The vacuum line 50 also terminates at a location having a height that is above the highest permitted level of liquid 32 in the waste collection tank 26. By terminating both the vacuum line 50 and the outlet opening 46 of the downstream section 42 of the vacuum pipe 16 above the highest permitted level of liquid 32 in the waste collection tank 26, the communication of a reduced pressure by the vacuum line 50 to the downstream section 42 of the vacuum pipe 16 is never impeded or obstructed by the liquid 32 in the waste collection tank 26.

As mentioned above, during operation of the vacuum system 10, the vacuum pump 24 applies a vacuum (a pressure less than the local ambient pressure) to the upper portion of the waste collection tank 26, thereby negatively pressurizing the system 10 including the main collection line 11 and the downstream section 42 of the vacuum pipe 16. A vacuum line 51 is coupled to the downstream section 42 of the vacuum pipe 16 at a location upstream of a check valve 53. The vacuum line 51 is coupled to the controller 20, and the check valve 53 is provided to maintain vacuum pressure in the downstream section 42 during draining of the waste collection tank 26, as discussed above.

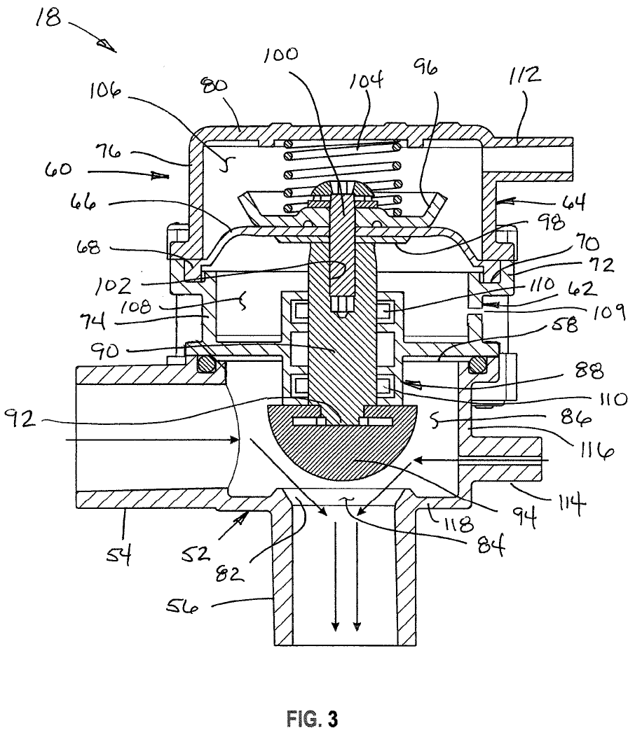

When the level sensor 34 detects that the liquid 32 in the accumulator 14 has reached the predetermined level for the accumulator 14, a signal is provided from the sensor to the valve controller 20. In response, the valve controller 20 applies a vacuum signal to the extraction valve 18, via vacuum line 38, and causes the extraction valve 18 to move from a closed state to an open state. In the open state, as seen in FIG. 3, the upstream section 40 of the vacuum pipe 16, which is at ambient or atmospheric pressure, is exposed to the reduced pressure in the downstream section 42 of the vacuum pipe 16. Resultantly, liquid 32 in the accumulator 14 is drawn into the upstream section 40 of the vacuum pipe 16, passed through the extraction valve 18, and discharged via the downstream section 42 and main collection line 11 into the waste collection tank 26.

After a predetermined period of time (which may be determined by the valve controller 20) or after the level of liquid 32 in the accumulator 14 has been lowered to a second predetermined level (which may be determined by a second level sensor, not shown), the controller 20 terminates the vacuum/control signal to extraction valve 18 and the extraction valve 18 closes, returning to its closed state.

As noted above, when the extraction valve 18 is closing, there is a high degree of pressure differential through and between the upstream and downstream ports of the extraction valve 18. As a result, the extraction valve 18 may experience cavitation, occurring at the vena contracta of the fluid stream and induced by the rapid acceleration in the flow velocity of the liquid 32 through the closing of the valve 18. Cavitation may and can be very destructive to the components of the extraction valve 18, to the downstream section 42 of the vacuum pipe 16, and to other components (i.e. check valves, etc.) downstream of the valve 18.

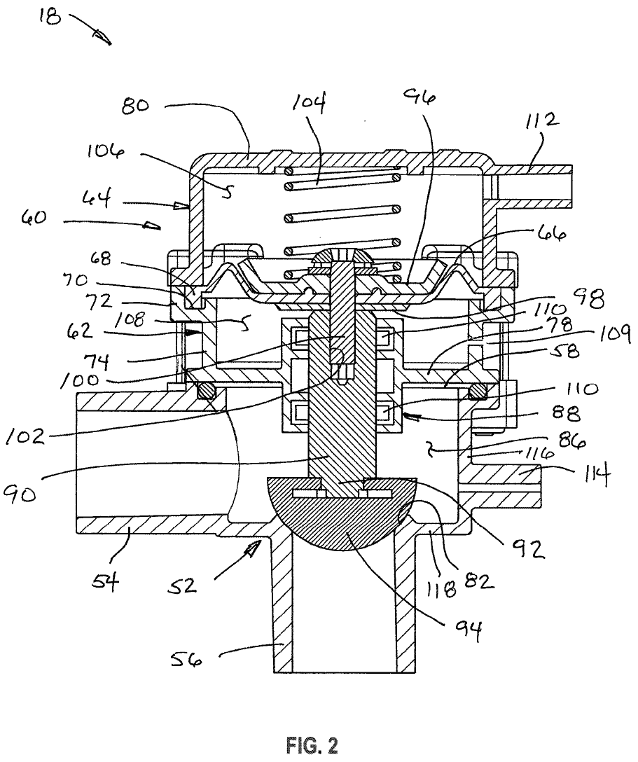

The extraction valve 18 disclosed herein, and utilized with the vacuum system 10 described above, mitigates and alleviates the development of cavitation. As previously noted, the closed and open states of the extraction valve 18 are respectively seen in FIGS. 2 and 3. While the extraction valve 18 is illustrated and is described as a vacuum actuated extraction valve 18, the valve 18 may be actuated by the controller 20 via other means, including without limitation, mechanical, electromechanical, and electro-magnetic means.

Referring now to FIGS. 2 and 3, the extraction valve 18 includes a valve body 52 having an inlet port 54 coupled to the upstream section 40 of the vacuum pipe 16 and an outlet port 56 coupled to the downstream section 42 of the vacuum pipe 16. The valve body 52 is generally cup shaped and on one side, the side opposite of the outlet port 56 in FIGS. 2 and 3, is provided with an opening 58, to which is mounted a valve bonnet 60.

The bonnet 60 is formed by a lower housing 62 and an upper housing 64. Separating the lower housing 62 from the upper housing 64 is a diaphragm 66, the outer perimeter of which is formed with a retaining feature 68 that is captively retained by the upper housing 64 in a groove 70 defined in the upper perimeter 72 of the lower housing 62. The lower and upper housings 62, 64 each respectively include side walls 74, 76 and lower and upper end walls 78, 80.

The outlet port 56 terminates in a valve seat 82 that defines an outlet opening 84 that communicates with a fluid chamber 86 defined by the valve body 52 between the inlet port 54 and the outlet port 56.

Mounted to the diaphragm 66 and extending therefrom, through a seal assembly 88 provided in the lower end wall 78, is a valve stem 90. At its terminal end 92 the valve stem 90 carries a valve member or plug 94, and, as seen in FIG. 2, the plug 94 is configured to sealingly engage the valve seat 82 of the valve body 52. To secure the valve stem 90 to the diaphragm 66, upper and lower face plates 96, 98 are respectively located on upper and lower sides of the diaphragm 66 and a threaded fastener 100 extends through apertures in the upper face plate 96, the diaphragm 66 and the lower face plate 98, after which it engages in a threaded bore 102 defined in the valve stem 90. A spring 104, provided in an upper chamber 106 defined by the upper housing 64, is registered about the threaded fastener 100 and exerts a biasing force on the diaphragm 66 such that, at ambient pressure in the upper chamber 106, the plug 94 is sealingly engaged with the valve seat 82 and the extraction valve 18 is closed. A lower chamber 108, defined on its lateral sides and bottom side by the lower housing 62 and on its upper side by the diaphragm 66, is maintained at ambient pressure via a port 109 defined in the lower housing 62.

The seal assembly 88, provided in the lower end wall 78 of the lower housing 62, may be of any construction that allows for reciprocal movement of the valve stem 90 therethrough while maintaining a fluid tight seal about the valve stem 90 and between the lower chamber 108 and the fluid chamber 86. In the illustrated construction, the seal assembly 88 includes a plurality of spaced apart seals 110, which may be lip-seals, X-seals, O-rings or other seals capable of achieving the above stated effect.

The extraction valve 18 is normally closed with both the upper and lower chambers 106 and 108 at atmospheric pressure and the spring 104 biasing the diaphragm 66 to cause engagement of the plug 94 with the valve seat 82, closing off the outlet opening defined thereby. When the level sensor 34 detects that the liquid 32 in the accumulator 14 has reached the predetermined level, a signal is provided to the valve controller 20 and the valve controller 20 applies a signal to the extraction valve 18. In the illustrated embodiment, the extraction valve 18 is pneumatically actuated by the valve controller 20 and, for this purpose, includes an activation port 112 in fluid communication with the upper chamber 106.

The activation port 112 is provided as part of the upper housing 64 and, as noted above, defines a passageway in fluid communication with the upper chamber 106. When vacuum is applied to the upper chamber 106 via the activation port 112, the higher, ambient pressure in the lower chamber 108, acting on the diaphragm 66, is able to overcome the biasing force of the spring 104. As a result, as the diaphragm 66 deflects toward the upper end wall 80, the spring is compressed and the valve stem 90 lifts the plug 94 from engagement with the valve seat 82, thereby moving the extraction valve 18 from the closed state of FIG. 2 to the open state of FIG. 3. When the extraction valve 18 is in the open state, the upstream section 40 of the vacuum pipe 16 is exposed to the reduced pressure in the downstream section 42 of the vacuum pipe 16. Resultantly, liquid 32 is drawn from the accumulator 14, through the extraction valve 18, and discharged into the waste collection tank 26.

After a predetermined period of time (which may be determined by the valve controller 20), or after the level of liquid 32 in the accumulator 14 has been lowered to the second predetermined level, the controller 20 terminates the control signal applied to the actuation port 112 and the pressure within the upper chamber 106 is brought back to ambient, thereby allowing the spring 104 to bias the plug 94 into engagement with the valve seat 82, returning the extraction valve 18 to its closed state.

As the extraction valve 18 is closing and the gap between the plug 94 and valve seat 82 is decreasing, a high pressure differential is created through and between the upstream and downstream ports 54, 56 of the extraction valve 18. As a result, the flow rate of the liquid 32 through the valve 18 may undergo rapid acceleration, resulting in a lower pressure in the liquid 32 and inducement of cavitation downstream of the extraction valve 18.

In order to combat the development of cavitation, the extraction valve 18 includes an air or induction port 114. The induction port 114 is formed in the valve body 52 and defines a passageway in fluid communication with the fluid chamber 86 at a location upstream of the valve seat 82. The passageway has a diameter significantly smaller that the diameters of passageways defined by the inlet and outlet ports 54, 56. By significantly smaller it is meant that the area of the passageway through the air passageway is at least 50% smaller than the inlet and/or outlet ports 54, 56; more preferably at least 75% smaller; and still more preferably at least 90% smaller. In the illustrated embodiment, the induction port 114 is formed in a side wall 116 of the valve body 52, as is the inlet port 54. Alternatively, the induction port 114 may be formed in the bottom wall 118 of the valve body 52, the wall opposite of the opening 58, or elsewhere in the valve body 52.

The induction port 114 is coupled to a source of pressure that is above the lower pressure of the downstream section 42 of the vacuum pipe 16. Preferably, the induction port 114 is coupled to a source of ambient pressure. By introducing ambient or an elevated pressure air into fluid chamber 86, the pressure in fluid chamber 86 is elevated above the pressure at which cavitation is induced, essentially increasing the surface pressure of the liquid 32 at the interface of plug 94 and chamber 86. This increase in pressure is sufficient to prevent the onset of cavitation.

The above description is meant to be illustrative of at least one preferred implementation incorporating the principles of the invention. One skilled in the art will really appreciate that the invention is susceptible to modification, variation and change without departing from the true spirit and fair scope of the invention, as defined in the claims that follow. The terminology used herein is therefore intended to be understood in the nature of words of description and not words of limitation.

We claim:

1. An extraction valve comprising:
a valve body, the valve body having an inlet port defining an inlet passageway, an outlet port defining an outlet passageway, and portions defining a valve seat generally located between the inlet port and the outlet port;
a bonnet, the bonnet mounted to the valve body and cooperating with the valve body to define a fluid chamber communicating the inlet port with the outlet port;
the bonnet including a valve member disposed within the fluid chamber and moveable between an engaged position with the valve seat and a disengaged position with the valve seat, in the engaged position the valve member preventing fluid communication between the inlet port and the outlet port; and
an induction port defined in the valve body, the induction port defining a passageway in fluid communication with the fluid chamber.

2. The extraction valve according to claim 1, wherein the induction port is located upstream of the valve seat.

3. The extraction valve according to claim 1, wherein the induction port is located in a side wall of the valve body.

4. The extraction valve according to claim 1, wherein the passageway of the induction port has a cross-sectional area smaller than a cross-sectional area of the inlet passageway.

5. The extraction valve according to claim 1, wherein the induction port is coupled to a source of ambient pressure.

6. A liquid collection system comprising:
a liquid collection device;
an accumulator, the liquid collection device being coupled to the accumulator whereby liquid from the collection device is transferred to the accumulator;
a vacuum pipe, the vacuum pipe having an upstream portion and a downstream portion, the upstream portion being coupled to the accumulator;
an extraction valve coupled to the vacuum pipe;
a valve controller, the valve controller coupled to the extraction valve; and
a vacuum pump, the vacuum pump coupled to the downstream portion of the vacuum pipe;
the extraction valve including a valve body, the valve body having an inlet port defining an inlet passageway, an outlet port defining an outlet passageway, and portions defining a valve seat generally located between the inlet port and the outlet port, a bonnet, the bonnet being mounted to the valve body and cooperating with the valve body to define a fluid chamber communicating the inlet port with the outlet port, the bonnet including a valve member disposed within the fluid chamber and being moveable between first position engaged with the valve seat and a second position disengaged from the valve seat, in the first position the valve member preventing fluid communication between the inlet port and the outlet port, and an induction port defined in the valve body, the induction port defining a passageway in fluid communication with the fluid chamber.

7. The system according to claim 6, wherein the induction port is located upstream of the valve seat.

8. The system according to claim 6, wherein the induction port is located in a side wall of the valve body.

9. The system according to claim 6, wherein the passageway of the induction port has a cross-sectional area smaller than a cross-sectional area of the inlet passageway.

10. The system according to claim 6, wherein the induction port is coupled to a source of ambient pressure.
